(19) United States
(12) Patent Application Publication
(10) Pub. No.: US 2014/0173203 A1
(43) Pub. Date: Jun. 19, 2014

(54) Block Memory Engine

(71) Applicant: Andrew T. Forsyth, Kirkland, WA (US)

(72) Inventor: Andrew T. Forsyth, Kirkland, WA (US)

(21) Appl. No.: 13/717,981

(22) Filed: Dec. 18, 2012

(51) Int. Cl. G06F 12/08

(52) U.S. Cl. CPC G06F 12/0862; G06F 12/0875
USPC 711/120

(57) ABSTRACT

In an embodiment, a processor is disclosed and includes a cache memory and a memory execution cluster coupled to the cache memory. The memory execution cluster includes a memory execution unit to execute instructions including non-block memory instructions, and block memory logic to execute one or more block memory operations. Other embodiments are described and claimed.

### BACKGROUND

An execution unit of a processor core is typically designed to efficiently process arithmetic instructions. The execution unit is typically much less efficient at executing certain memory instructions.

A direct memory access (DMA) unit may be added outside of the processor core to perform selected memory instructions, but a DMA unit typically requires considerable operating system support that can place an additional load on the execution unit. Additionally, a DMA unit is typically connected to a distant level of cache hierarchy, or else directly to dynamic random access memory (DRAM), and therefore is not time-efficient, e.g., when accessing buffers that are cache-resident.

### BRIEF DESCRIPTION OF THE DRAWINGS

FIG. 1 is a block diagram of a system in accordance with an embodiment of the invention.

FIG. 2 is a block diagram of a portion of the system in accordance with an embodiment of the present invention.

FIG. 3 is a block diagram of a method of executing instructions in a memory execution cluster (MEC) in accordance with an embodiment of the present invention.

FIG. 4 is a block diagram of a processor core in accordance with one embodiment of the present invention.

FIG. 5 is a block diagram of a processor in accordance with an embodiment of the present invention.

FIG. 6 is an illustration of an embodiment of a processor including multiple cores in accordance with an embodiment of the present invention.

FIG. 7 is a block diagram of a system in accordance with an embodiment of the present invention.

### DETAILED DESCRIPTION

A memory execution cluster (MEC) of a processor pipeline may include block memory logic, e.g., a block memory engine configured to autonomously execute one or more block memory operations independent of a memory execution unit (MEU) of the MEC. The block memory logic may be configured to perform, with regard to blocks of memory, any of initialize, copy, compare, find, prefetch, and evict instructions autonomously, e.g., in parallel with the MEU executing non-block memory instructions such as single load instructions and store instructions. Data blocks to be operated upon can include a set of multiple cache lines, one or more pages of data (e.g., 4 K bytes per page), or other larger sets of data. By configuring the block memory logic to perform one or more of these six instructions, processing speed of the MEC may be increased and power consumption may be reduced as compared with execution of both non-block memory instructions and block memory operations by the MEU.

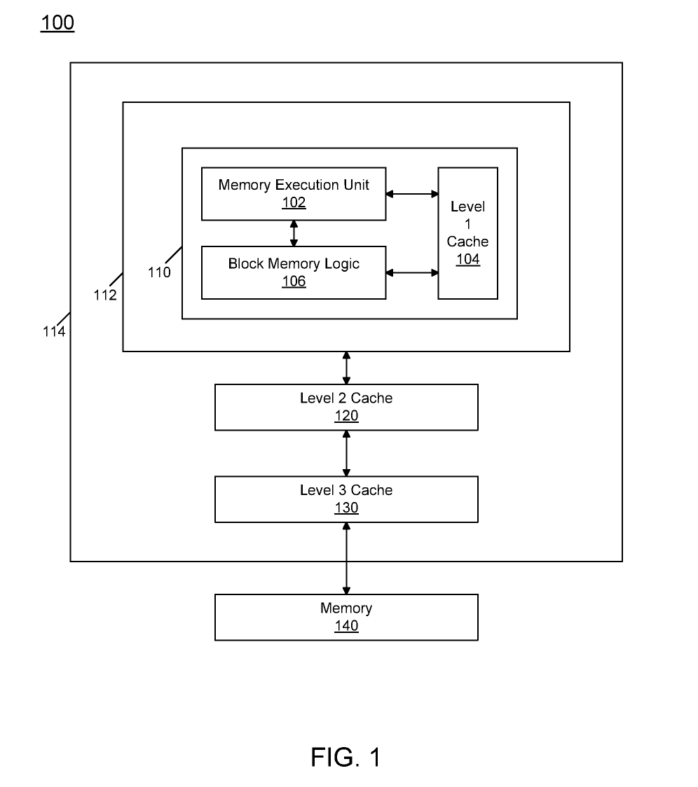

Referring to FIG. 1, a block diagram of a system 100 is shown, according to an embodiment of the invention. The system 100 includes a processor 114 including a core 112 that includes a memory execution cluster (MEC) 110, level 2 cache 120, and level 3 cache 130. The system 100 also includes a system memory 140, which may be, e.g., a dynamic random access memory (DRAM). The MEC 110 may include an MEU 102, level 1 cache 104, and block memory logic 106.

In an embodiment, the block memory logic 106 is configured to perform block memory operations that may include any or all of initialize, copy, compare, find, prefetch, and evict instructions that are directed to any of the cache memories 104, 120, 130, or to the system memory 140. The block memory logic 106 may include internal logic, e.g., hardware, firmware, or software that is configured to efficiently execute one or more of the block memory operations. The block memory logic 106 that is to perform block memory operations may be specifically designed, e.g., via dedicated logic, to execute the block memory operations in a time-efficient and/or power-efficient manner. Data movement by the block memory logic 106 may be any or all of coherent, well-ordered, virtual, and cached.

In an embodiment, some of the block memory operations, e.g., initialize and copy, can spot when an entire cache line is to be written to, which would obliterate contents of the cache line. When such an instruction is executed, a “read for ownership—no data” request may be issued that gives, to the instruction, ownership of the cache line without causing an actual read of the contents that may reduce memory bandwidth needed and latency to line ownership. This type of request can be made when the processor knows that the entire line is to be overwritten by a single uninterruptable operation, and thus does not need to read the contents from memory or lower-level caches beforehand, since all elements are to be replaced. The operation is to be uninterruptable because if it is not uninterruptable, then not reading the cache line can cause stale memory in the caches. The block memory logic can facilitate ease of executing a “read for ownership—no data” request.

In an embodiment, either a source, a destination, or both source and destination of a block memory operation executed by the block memory logic 106 may be uncached. Avoiding caching of block data may be advantageous certain situations. For example, when a block of data is to be copied to a temporary area (destination), operated upon, and then discarded, the source of the data is typically read only once, e.g., when copying to the temporary area. Caching data that will be read only once can unnecessarily occupy cache space that could otherwise be used for other data. Instead, the block data may be duplicated with an operation that caches a destination copy but does not cache the source. Later instructions can modify this destination copy of the data.

By dedicating the block memory logic 106 to execution of block memory operations, loading of the MEU 102 may be reduced, and the MEU 102 and the block memory logic 106 can perform their respective subsets of instructions in a time-efficient manner. In addition, reduction of the load on the MEU 102 may result in a savings of electrical power as compared with execution of all instructions by the MEU 102.

In an embodiment, the block memory operations that the block memory logic 106 may be configured to efficiently execute may include the following instructions:
Initialize—set a block of memory to a given value, e.g., zero.
Find—search to locate a match to a supplied value, e.g., find a particular value in a list
Prefetch—import a block of memory from a distant cache level (or from DRAM) into a nearby cache level.
Evict—push a block of memory out of a nearby cache level (e.g., to make room for other data) into further a cache level or into the system memory.
Copy—copy a block of memory from one location to another location.
Compare—compare contents of two blocks of memory and report location of a first detected difference.

One or more of the above-described instructions may be executed in conjunction with one or more flags indicating, e.g., whether or not to cache source, or destination, or both source and destination.

In an embodiment, a set of instruction definitions for these block memory operations may be user level instructions of a given instruction set to enable block memory operations with a reduced programming burden. An example of a set of user level instructions is as follows. It is to be noted that instruction names are exemplary and may differ in other embodiments, and that register identities are exemplary and may differ in other embodiments.

| INSTRUCTION | NAME | DESCRIPTION |
|---|---|---|
| Initialize | BMINT [r8], r9, | set [r8] to [r8 + r9 − 1] to a value |
| | r10 | r10 |
| Find | BMSCANEQ r8, | find first value within range |
| | r9, [r10] | [r10] − [r10 + r8 − 1] that is equal |
| | | to a value of r9, and store offset |
| | | within in location r8 |
| Prefetch | BMPREFETCHn, | prefetch memory block [r8] to |
| | [r8], r9 | [r8 + r9 − 1] into cache level n |
| Evict | BMEVICTn [r8], | evict memory block [r8] to |
| | r9 | [r8 + r9 − 1] from cache level n |
| Copy | BMCOPY [r8], | copy the block [r9] − [r9 + r10] to |
| | [r9], r10 | [r8] − [r8 + r10] |
| Compare | BMCMP [r8], | compare the block [r8] − [r8 + |
| | [r9], r10 | r10] to the block [r9] − [r9 + r10]. |
| | | If they are equal set Z flag; if not |
| | | equal, set r10 to the offset of the |
| | | difference and clear Z flag. |

Other definitions of user-level instructions are possible and may be used in other embodiments.

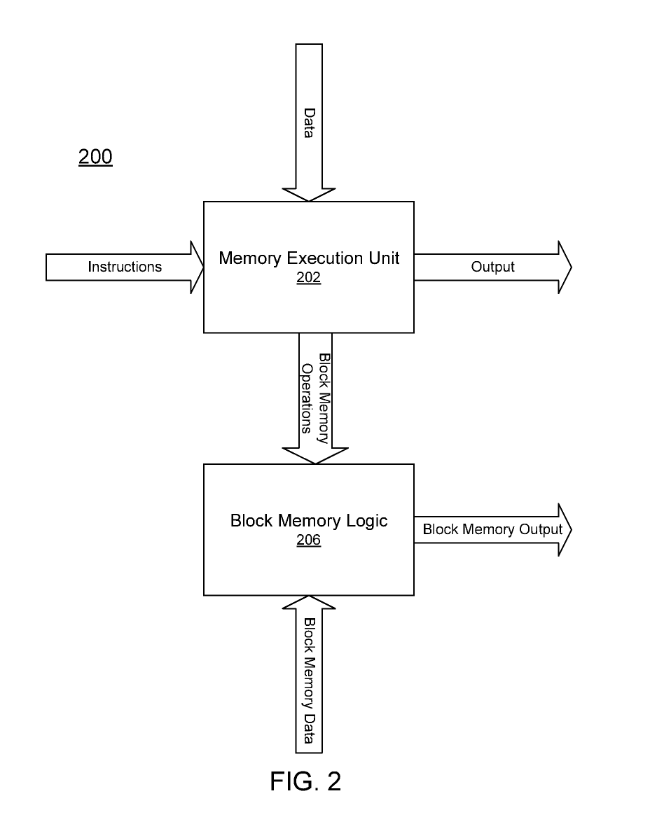

Referring now to FIG. 2, a block diagram of a portion of the MEC 110 of system 100 is depicted. Shown are an MEU 202 and block memory logic 206. In operation, the MEU 202 may fetch instructions from an instruction cache (not shown). Block memory operations may be sent to the block memory logic 206 for execution. The MEU 202 may execute all non-block memory instructions, e.g., single loads, stores, and other non-block memory instructions, and the block memory logic 206 may execute all block memory operations in parallel with the execution of non-block memory instructions by the MEU 202. In an embodiment, the memory execution unit 202 is an out-of-order machine and a thread of the memory execution unit 202 that sends the block memory operation to the block memory logic 206 can execute an out of order instruction or operation while the block memory logic 206 executes the block memory operation. Without the block memory logic present, a single instruction to perform a block operation might otherwise be turned into multiple operations for the MEU 202, typically requiring more time or energy to execute, and reducing performance or raising power consumed. Further, operation of the MEU 202 in parallel with the block memory logic 206 may result in further improved time efficiency as compared with execution of all instructions by the MEU 202.

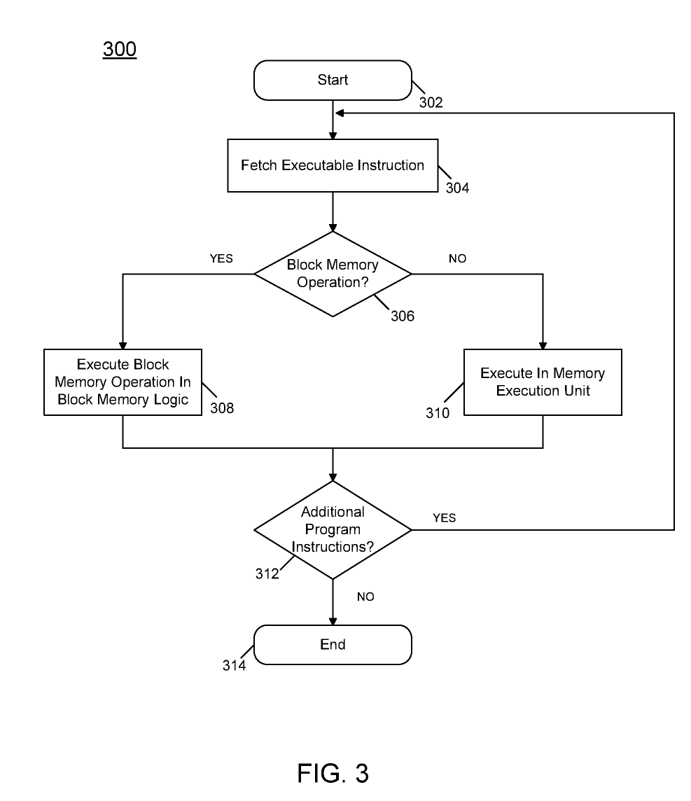

Referring now to FIG. 3, a method 300 of executing instructions in a memory execution cluster (MEC) is shown. The method starts at block 302. Moving to block 304, an executable instruction of a program is fetched by the MEC. Moving to diamond 306, it is determined whether the instruction is a block memory operation. If the instruction is a block memory operation control is transferred to block 308, where the block memory operation is executed in block memory logic, such as the block memory logic 106 of FIG. 1. Back at diamond 306, if it is determined that the instruction is a non-block memory instruction, e.g., a single load or store instruction, control passes to block 310 where the instruction is executed in a memory execution unit, such as the MEU 102 of FIG. 1. After the instruction is executed at block 308 or at block 310, control passes to diamond 312, where it is determined whether there are additional instructions to be executed. If additional instructions remain to be executed, the method returns to block 304 to fetch the next instruction of the program. If no more instructions remain to be executed, the method ends at block 314.

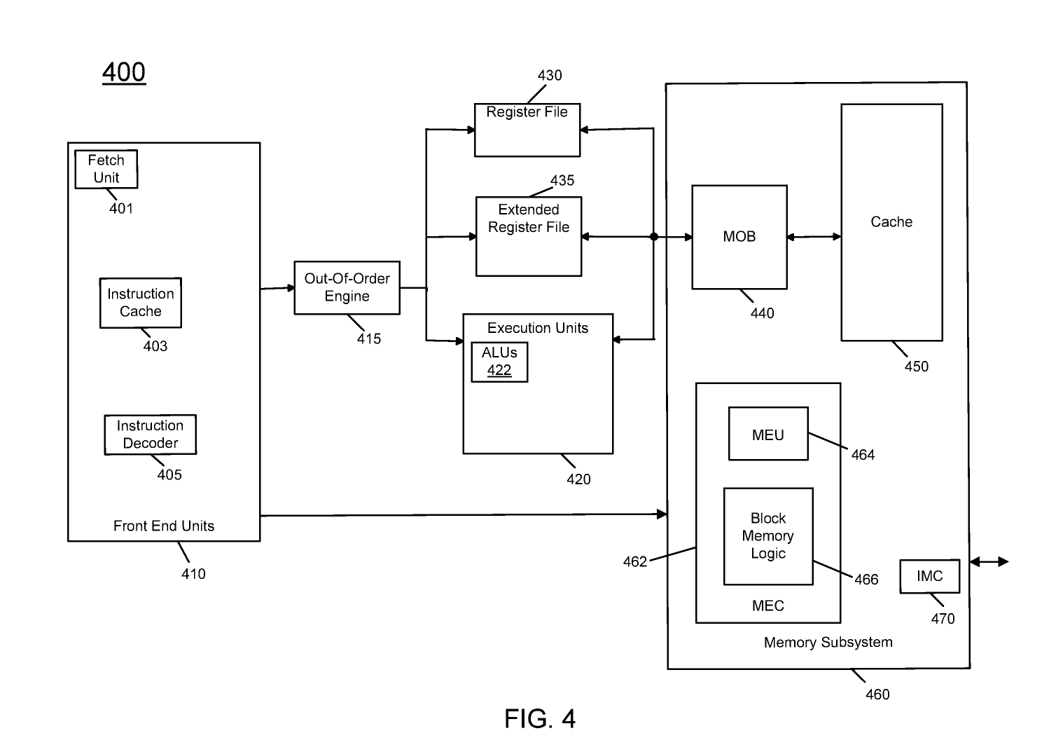

Referring now to FIG. 4, shown is a block diagram of a processor core 400 in accordance with one embodiment of the present invention. The processor core 400 may be one core of a multicore processor, and is shown in FIG. 4 as a multi-stage pipelined out-of-order processor. Processor core 400 is shown with a relatively simplified view in FIG. 4 to illustrate various features used in connection with execution of block memory operations in accordance with an embodiment of the present invention.

As shown in FIG. 4, core 400 includes front end units 410, which may be used to fetch instructions for execution and to prepare them for use later in the processor. For example, front end units 410 may include a fetch unit 401, an instruction cache 403, and an instruction decoder 405. In some implementations, front end units 410 may further include a trace cache, along with microcode storage as well as a micro-operation storage. Fetch unit 401 may fetch macro-instructions, e.g., from memory or instruction cache 403, and feed them to instruction decoder 405 to decode them into primitives, i.e., micro-operations for execution by the processor.

Coupled between front end units 410 and execution units 420 is an out-of-order (OOO) engine 415 that may be used to receive the micro-instructions and prepare them for execution. More specifically OOO engine 415 may include various buffers to re-order micro-instruction flow and allocate various resources needed for execution, as well as to provide renaming of logical registers onto storage locations within various register files such as register file 430 and extended register file 435 such as by using renaming logic of the engine. Register file 430 may include separate register files for integer and floating point operations. Extended register file 435 may provide storage for vector-sized units, e.g., 256 or 512 bits per register.

Various resources may be present in execution units 420, including, for example, various integer, floating point, and single instruction multiple data (SIMD) logic units, among other specialized hardware. For example, such execution units may include one or more arithmetic logic units (ALUs) 422. Of course other execution units such as multiply-accumulate units and so forth may further be present.

Results of the execution units 420 may be provided to a retirement logic, which may be implemented within a memory subsystem 460 of the processor. Various processor structures including execution units and front end logic, for example, may be coupled to a memory subsystem 460. This memory subsystem may provide an interface between processor structures and further portions of a memory hierarchy, e.g., an on or off-chip cache and a system memory. As seen the subsystem has various components including a memory order buffer (MOB) 440. More specifically, MOB 440 may include various arrays and logic to receive information associated with instructions that are executed. This information is then examined by MOB 440 to determine whether the instructions can be validly retired and result data committed to the architectural state of the processor, or whether one or more exceptions occurred that prevent a proper retirement of the instructions. Of course, MOB 440 may handle other operations associated with retirement.

As shown in FIG. 4, MOB 440 is coupled to a cache 450 which, in one embodiment may be a low level cache (e.g., an L1 cache). Memory subsystem 460 also may include an integrated memory controller 470 to provide for communication with a system memory (not shown for ease of illustration in FIG. 4). Memory subsystem 460 may further include a memory execution cluster (MEC) 462 including a memory execution unit (MEU) 464 that handles various operations to initiate memory requests and to handle return of data from the system memory. Further, while not shown understand that other structures such as buffers, schedulers and so forth may be present in the MEU 464. The MEC 462 may further include block memory logic 466 that is configured to efficiently execute block memory operations and that is dedicated to execution of block memory operations, as described herein.

From memory subsystem 460, data communication may occur with higher level caches, the system memory and so forth. While shown with this high level in the embodiment of FIG. 4, understand the scope of the present invention is not limited in this regard. For example, while the implementation of FIG. 4 is with regard to an out-of-order machine such as of a so-called “Intel Architecture” or “x86” instruction set architecture (ISA), the scope of the present invention is not limited in this regard. That is, other embodiments may be implemented in an in-order processor, a reduced instruction set computing (RISC) processor such as an ARM-based processor, or a processor of another type of ISA that can emulate instructions and operations of a different ISA via an emulation engine and associated logic circuitry.

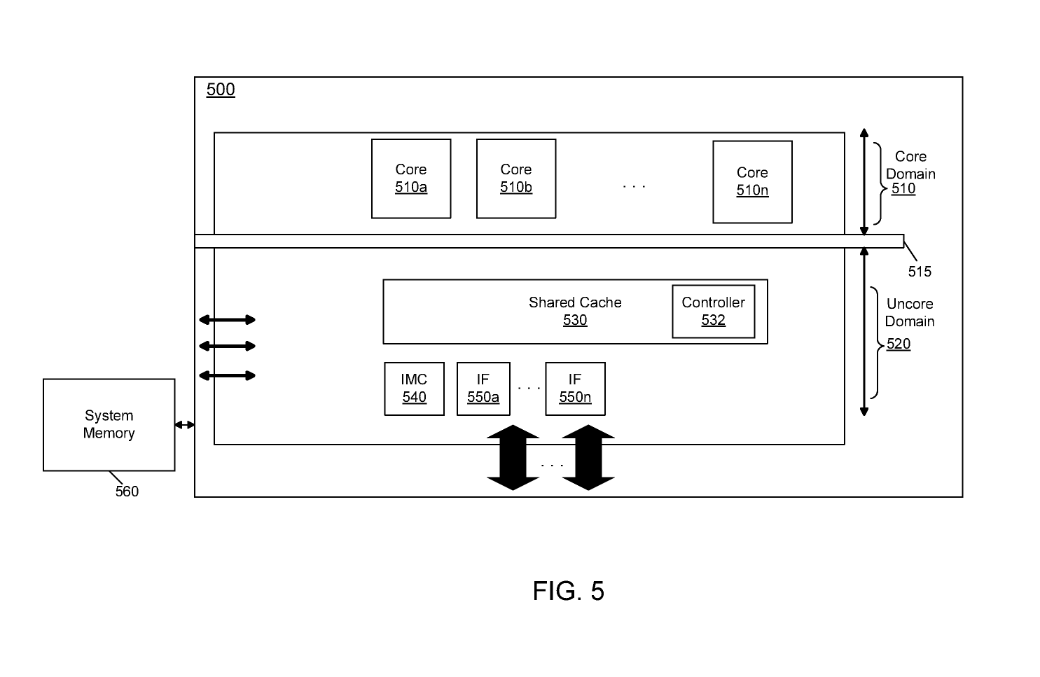

Referring now to FIG. 5, shown is a block diagram of a processor in accordance with an embodiment of the present invention. As shown in FIG. 5, processor 500 may be a multicore processor including a plurality of cores 510a-510n in a core domain 510. One or more of the cores may include a memory execution cluster including a memory execution unit, and block memory logic dedicated to execution of block memory operations, as described herein. The block memory logic may execute the block memory operations input to the memory execution cluster and the memory execution unit may execute non-block memory instructions input to the memory execution cluster. The cores may be coupled via an interconnect 515 to a system agent or uncore 520 that includes various components. As seen, the uncore 520 may include a shared cache 530 which may be a last level cache and includes a cache controller 532. In addition, the uncore may include an integrated memory controller 540 and various interfaces 550.

With further reference to FIG. 5, processor 500 may communicate with a system memory 560, e.g., via a memory bus. In addition, by interfaces 550, connection can be made to various off-chip components such as peripheral devices, mass storage and so forth. While shown with this particular implementation in the embodiment of FIG. 5, the scope of the present invention is not limited in this regard.

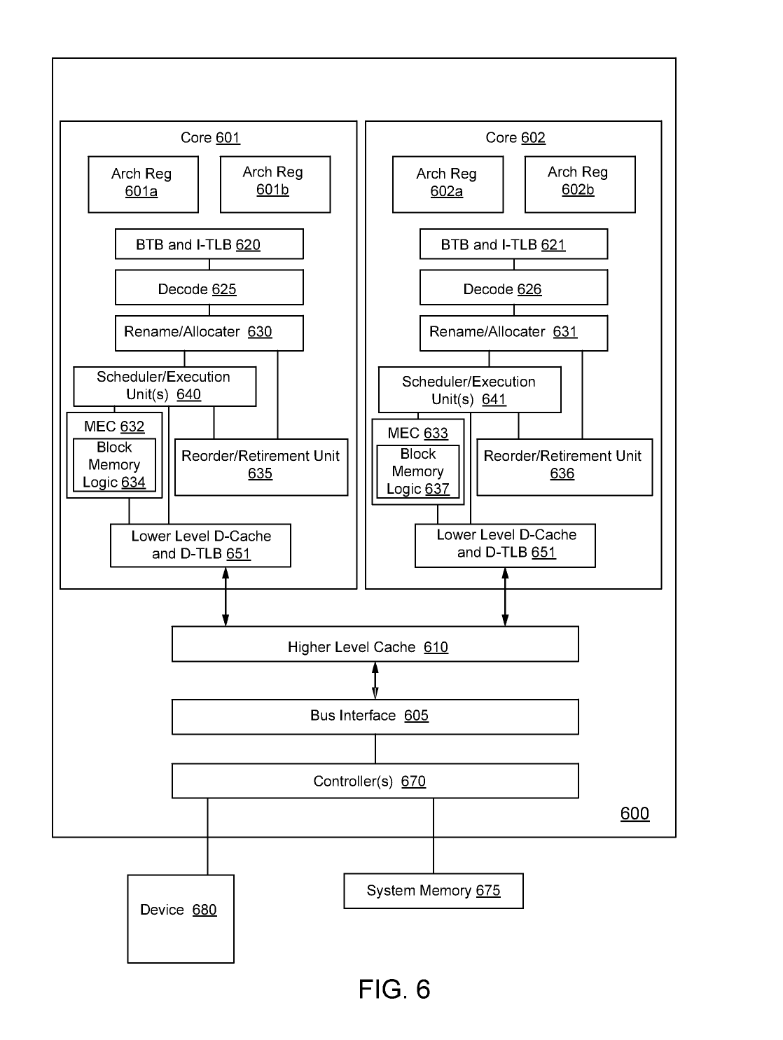

Referring to FIG. 6, an embodiment of a processor including multiple cores is illustrated. Processor 600 includes any processor or processing device, such as a microprocessor, an embedded processor, a digital signal processor (DSP), a network processor, a handheld processor, an application processor, a co-processor, a system on a chip (SOC), or other device to execute code. Processor 600, in one embodiment, includes at least two cores—cores 601 and 602, which may include asymmetric cores or symmetric cores (the illustrated embodiment). However, processor 600 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 600, as illustrated in FIG. 6, includes two cores, cores 601 and 602. Here, cores 601 and 602 are considered symmetric cores, i.e., cores with the same configurations, functional units, and/or logic. In another embodiment, core 601 includes an out-of-order processor core, while core 602 includes an in-order processor core. However, cores 601 and 602 may be individually selected from any type of core, such as a native core, a software managed core, a core adapted to execute a native instruction set architecture (ISA), a core adapted to execute a translated ISA, a co-designed core, or other known core. Yet to further the discussion, the functional units illustrated in core 601 are described in further detail below, as the units in core 602 operate in a similar manner.

As depicted, core 601 includes two hardware threads 601a and 601b, which may also be referred to as hardware thread slots 601a and 601b. Therefore, software entities, such as an operating system, in one embodiment potentially view processor 600 as four separate processors, i.e., four logical processors or processing elements capable of executing four software threads concurrently. As alluded to above, a first thread is associated with architecture state registers 601a, a second thread is associated with architecture state registers 601b, a third thread may be associated with architecture state registers 602a, and a fourth thread may be associated with architecture state registers 602b. Here, each of the architecture state registers (601a, 601b, 602a, and 602b) may be referred to as processing elements, thread slots, or thread units, as described above. As illustrated, architecture state registers 601a are replicated in architecture state registers 601b, so individual architecture states/contexts are capable of being stored for logical processor 601a and logical processor 601b. In core 601, other smaller resources, such as instruction pointers and renaming logic in allocator and renamer block 630 may also be replicated for threads 601a and 601b. Some resources, such as re-order buffers in reorder/retirement unit 635, ILTB 620, load/store buffers, and queues may be shared through partitioning. Other resources, such as general purpose internal registers, page-table base register(s), low-level data-cache and data-TLB 615, execution unit(s) 640, and portions of out-of-order unit 635 are potentially fully shared.

Processor 600 often includes other resources, which may be fully shared, shared through partitioning, or dedicated by/to processing elements. In FIG. 6, an embodiment of a purely exemplary processor with illustrative logical units/resources of a processor is illustrated. Note that a processor may include, or omit, any of these functional units, as well as include any other known functional units, logic, or firmware not depicted. As illustrated, core 601 includes a simplified, representative out-of-order (OOO) processor core. But an in-order processor may be utilized in different embodiments. The OOO core includes a branch target buffer 620 to predict branches to be executed/taken and an instruction-translation buffer (I-TLB) 620 to store address translation entries for instructions.

Core 601 further includes decode module 625 coupled to fetch unit 620 to decode fetched elements. Fetch logic, in one embodiment, includes individual sequencers associated with thread slots 601a, 601b, respectively. Usually core 601 is associated with a first ISA, which defines/specifies instructions executable on processor 600. Often machine code instructions that are part of the first ISA include a portion of the instruction (referred to as an opcode), which references/specifies an instruction or operation to be performed. Decode logic 625 includes circuitry that recognizes these instructions from their opcodes and passes the decoded instructions on in the pipeline for processing as defined by the first ISA. For example, decoders 625, in one embodiment, include logic designed or adapted to recognize specific instructions, such as transactional instruction. As a result of the recognition by decoders 625, the architecture or core 601 takes specific, predefined actions to perform tasks associated with the appropriate instruction. It is important to note that any of the tasks, blocks, operations, and methods described herein may be performed in response to a single or multiple instructions, some of which may be new or old instructions.

In one example, allocator and renamer block 630 includes an allocator to reserve resources, such as register files to store instruction processing results. However, threads 601a and 601b are potentially capable of out-of-order execution, where allocator and renamer block 630 also reserves other resources, such as reorder buffers to track instruction results. Unit 630 may also include a register renamer to rename program/instruction reference registers to other registers internal to processor 600. Reorder/retirement unit 635 includes components, such as the reorder buffers mentioned above, load buffers, and store buffers, to support out-of-order execution and later in-order retirement of instructions executed out-of-order.

Scheduler and execution unit(s) block 640, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

One or both of cores 601 and 602 may include a respective memory execution cluster (MEC) 632, 633, each MEC including block memory logic 634, 637 respectively, to execute block memory operations in accordance with embodiments of the present invention. In an embodiment, the block memory logic 634, 637 may execute the block memory operations while a respective memory execution unit (not shown) within the respective MEC 632, 633 executes one or more non-block memory instructions.

Lower level data cache and data translation buffer (D-TLB) 650 are coupled to execution unit(s) 640. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 601 and 602 share access to higher-level or further-out cache 610, which is to cache recently fetched elements. Note that higher-level or further-out refers to cache levels increasing or getting further away from the execution unit(s). In one embodiment, higher-level cache 610 is a last-level data cache—last cache in the memory hierarchy on processor 600—such as a second or third level data cache. However, higher level cache 610 is not so limited, as it may be associated with or includes an instruction cache. A trace cache—a type of instruction cache—instead may be coupled after decoder 625 to store recently decoded traces.

In the depicted configuration, processor 600 also includes bus interface module 605. Historically, controller 670 has been included in a computing system external to processor 600. In this scenario, bus interface 605 is to communicate with devices external to processor 600, such as system memory 675, a chipset (often including a memory controller hub to connect to memory 675 and an I/O controller hub to connect peripheral devices), a memory controller hub, a northbridge, or other integrated circuit. And in this scenario, bus 605 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 675 may be dedicated to processor 600 or shared with other devices in a system. Common examples of types of memory 675 include DRAM, SRAM, non-volatile memory (NV memory), and other known storage devices. Note that device 680 may include a graphic accelerator, processor or card coupled to a memory controller hub, data storage coupled to an I/O controller hub, a wireless transceiver, a flash device, an audio controller, a network controller, or other known device.

Note however, that in the depicted embodiment, the controller 670 is illustrated as part of processor 600. Recently, as more logic and devices are being integrated on a single die, such as SOC, each of these devices may be incorporated on processor 600. For example in one embodiment, memory controller hub 670 is on the same package and/or die with processor 600. Here, a portion of the core (an on-core portion) includes one or more controller(s) 670 for interfacing with other devices such as memory 675 or a graphics device 680. The configuration including an interconnect and controllers for interfacing with such devices is often referred to as an on-core (or un-core configuration). As an example, bus interface 605 includes a ring interconnect with a memory controller for interfacing with memory 675 and a graphics controller for interfacing with graphics processor 680. Yet, in the SOC environment, even more devices, such as the network interface, co-processors, memory 675, graphics processor 680, and any other known computer devices/interface may be integrated on a single die or integrated circuit to provide small form factor with high functionality and low power consumption.

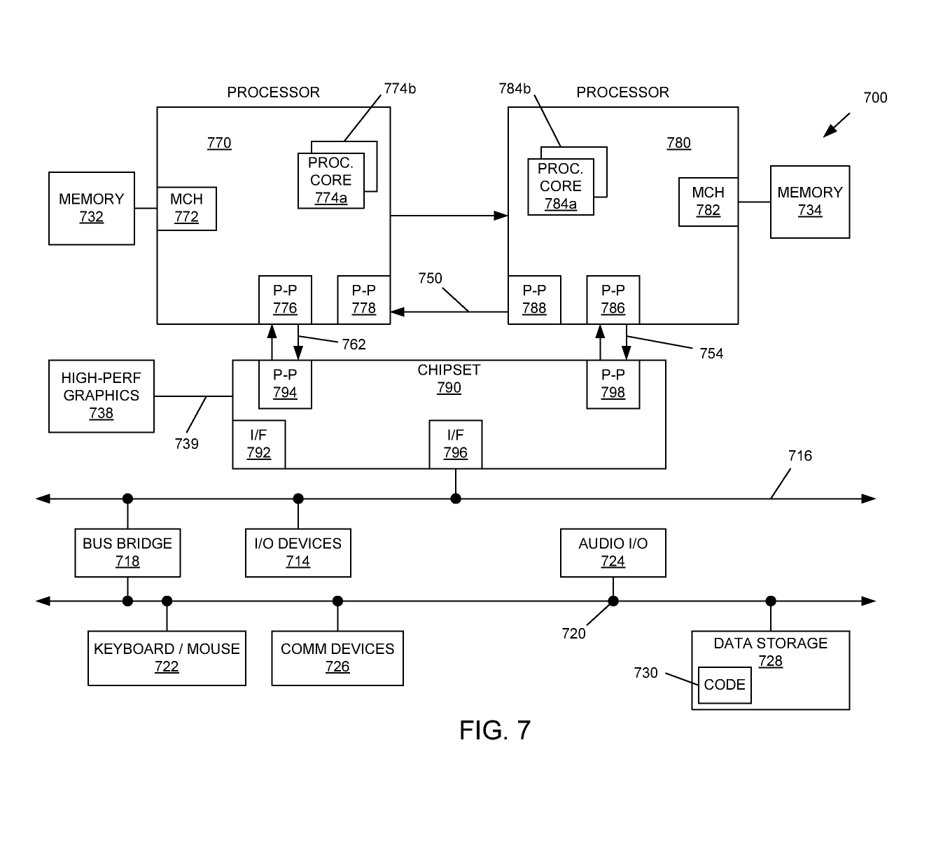

Embodiments may be implemented in many different system types. Referring now to FIG. 7, shown is a block diagram of a system in accordance with an embodiment of the present invention. As shown in FIG. 7, multiprocessor system 700 is a point-to-point interconnect system, and includes a first processor 770 and a second processor 780 coupled via a point-to-point interconnect 750. As shown in FIG. 7, each of processors 770 and 780 may be multicore processors, including first and second processor cores (i.e., processor cores 774a and 774b and processor cores 784a and 784b), although potentially many more cores may be present in the processors.

Still referring to FIG. 7, first processor 770 further includes a memory controller hub (MCH) 772 and point-to-point (P-P) interfaces 776 and 778. Similarly, second processor 780 includes a MCH 782 and P-P interfaces 786 and 788. As shown in FIG. 7, MCH's 772 and 782 couple the processors to respective memories, namely a memory 732 and a memory 734, which may be portions of system memory (e.g., DRAM) locally attached to the respective processors. Each of the processors 770 and 780 may include a respective memory execution cluster (MEC) (not shown) and each MEC may include respective block memory logic configured to execute block memory operations while a respective memory execution unit of the corresponding MEC executes non-block memory instructions.

First processor 770 and second processor 780 may be coupled to a chipset 790 via P-P interconnects 752 and 754, respectively. As shown in FIG. 7, chipset 790 includes P-P interfaces 794 and 798.

Furthermore, chipset 790 includes an interface 792 to couple chipset 790 with a high performance graphics engine 738, by a P-P interconnect 739. In turn, chipset 790 may be coupled to a first bus 716 via an interface 796. As shown in FIG. 7, various input/output (I/O) devices 714 may be coupled to first bus 716, along with a bus bridge 718 which couples first bus 716 to a second bus 720. Various devices may be coupled to second bus 720 including, for example, a keyboard/mouse 722, communication devices 726 and a data storage unit 728 such as a disk drive or other mass storage device which may include code 730, in one embodiment. Further, an audio I/O 724 may be coupled to second bus 720. Embodiments can be incorporated into other types of systems including mobile devices such as a smart cellular telephone, Ultrabook™, tablet computer, netbook, or so forth.

Embodiments may be implemented in code and may be stored on a non-transitory storage medium having stored thereon instructions which can be used to program a system to perform the instructions. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A processor comprising:
a cache memory; and
a memory execution cluster coupled to the cache memory, the memory execution cluster comprising:
a memory execution unit to execute instructions including non-block memory instructions; and
block memory logic to execute one or more block memory operations.

2. The processor of claim 1, wherein the block memory logic is configured to autonomously perform initialization of a block of memory to a given value responsive to a first block memory operation.

3. The processor of claim 1, wherein the block memory logic is configured to autonomously copy contents of a first storage block to a second storage block responsive to a second block memory operation.

4. The processor of claim 1, wherein the block memory logic is configured to compare a first block of memory to a second block of memory to determine whether there is a difference in stored data between corresponding storage locations of the first block of memory and the second block of memory, responsive to a third block memory operation.

5. The processor of claim 1, wherein the block memory logic is configured to execute a find operation to determine whether a match exists between a supplied value and any stored data value in a first block of memory.

6. The processor of claim 1, wherein the block memory logic is configured to execute a block prefetch of a first block of memory from a system memory to the cache memory responsive to a block prefetch operation.

7. The processor of claim 1, wherein the block memory logic is configured to execute a block evict operation to push a first block of memory out of an initial cache memory to another cache memory responsive to a block evict operation.

8. The processor of claim 1, wherein the block memory logic is configured to execute a block evict operation to push a first block of memory out of an initial cache memory to a system memory responsive to a block evict operation.

9. The processor of claim 1, wherein the block memory logic is configured to receive for execution, each block memory operation corresponding to a respective user level block memory instruction.

10. The processor of claim 1, wherein a first block memory operation includes a read for ownership request that upon execution claims ownership of a first portion of the cache memory for a subsequent write instruction.

11. The processor of claim 1, wherein the block memory logic is to execute a first block memory operation in parallel with the memory execution unit while the memory execution unit executes a first non-block memory instruction.

12. The processor of claim 1, wherein the block memory logic is to prefetch a first data block as part of execution of a first block memory operation, wherein a block prefetch is a configured operation of the block memory logic.

13. A method comprising:
receiving a first block memory operation in a memory execution cluster of a processor;
detecting the first block memory operation; and
executing the first block memory operation using block memory logic within the memory execution cluster, wherein the block memory logic is to execute block memory operations and wherein non-block memory instructions are to be executed by one of one or more memory execution units within the memory execution cluster that are distinct from the block memory logic.

14. The method of claim 13, wherein the block memory operation is a block evict operation that upon execution is to push a first block of memory out of a first memory to a second memory.

15. The method of claim 13, further comprising executing the block memory operation while the one memory execution unit executes one or more non-block memory instructions in parallel.

16. A system comprising:
a dynamic random access memory (DRAM) to store data; and
a processor including a memory execution cluster coupled to the DRAM, the memory execution cluster comprising:
a memory execution unit to execute non-block memory instructions; and
block memory logic configured to execute a block memory operation on a memory block stored in the DRAM or stored in a cache memory of the processor responsive to a user level block memory instruction, wherein the block memory operation is executed independent of the memory execution unit.

17. The system of claim 16, wherein the block memory logic is to execute the block memory operation by a prefetch of the memory block from the DRAM to one of one or more cache memories.

18. The system of claim 16, wherein the block memory logic is to execute the block memory operation in parallel with execution of a non-block memory instruction by the memory execution unit.

19. The system of claim 16, wherein the memory execution unit is to execute an out-of-order non-block memory instruction while the block memory logic executes the block memory operation.

20. The system of claim 16, wherein the block memory operation is a block evict operation to push a block of memory out of a cache memory of the processor to the DRAM.
